(19) United States
(12) Patent Application Publication
(10) Pub. No.: US 2008/0042790 A1
(43) Pub. Date: Feb. 21, 2008

(54) Linear actuator

(75) Inventors: Seong-Geun Kim, Suwon-si (KR); Jun-Kun Choi, Suwon-si (KR); Seuk-Hwan Chung, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/889,565

(22) Filed: Aug. 14, 2007

(30) Foreign Application Priority Data
Aug. 17, 2006 (KR) 10-2006-0077456

(51) Int. Cl. H01F 7/08

(52) U.S. Cl. 335/222

(57) ABSTRACT

A linear actuator is disclosed. A linear actuator that includes a first magnet and a second magnet secured with a predetermined gap in-between each other, a vibration magnet part interposed between the first magnet and the second magnet which is magnetized to repulse both the first magnet and the second magnet, and an electromagnet part interposed adjacent to the vibration magnet part that changes a magnetic field formed around the vibration magnet part, may provide high efficiency, by forming a magnetic spring from the repulsive forces of magnets and using the resonance of the magnetic spring.

### CROSS-REFERENCE TO RELATED APPLICATIONS

This application claims the benefit of Korean Patent Application No. 10-2006-0077456 filed with the Korean Intellectual Property Office on Aug. 17, 2006, the disclosure of which is incorporated herein by reference in its entirety.

### BACKGROUND

1. Technical Field

The present invention relates to a linear actuator.

2. Description of the Related Art

There are currently numerous vibration generator apparatus used for generating vibration in electronic devices such as cell phones, game consoles, and construction machinery, etc. However, existing vibration generator devices entail several problems in terms of life span and energy efficiency. A current actuators which uses rotation, may have the problem of short life span if brushes are used, and may require a separate chip if brushes are not used. When the actuator uses resonance between a weight and a spring made of an elastic substance, there may be a limitation in the durability of the spring, and there may be a problem in that the actuator is vulnerable to damage from falling. When the actuator uses the repulsion and attraction between a permanent magnet and an electromagnet, there may be the drawback of lowered energy efficiency.

FIG. 1 is a cross-sectional view of a linear actuator according to prior art. In FIG. 1 are illustrated a tube body 1 made of a non-magnetic substance, a actuator 2 made of a permanent magnet, a magnetic shield cover 3 made of a magnetized substance, electromagnets 4, and field magnet coils 5.

The linear actuator according to prior art shown in FIG. 1 generates vibration using the attraction and repulsion between a permanent magnet and electromagnets. Since this actuator depends only on electromagnetic forces, it is limited by low energy efficiency.

### SUMMARY

An aspect of the invention is to provide a linear actuator having high efficiency, by forming a magnetic spring from the repulsive forces of magnetic fields and using the resonance of the magnetic spring and a weight.

One aspect of the claimed invention provides a linear actuator that includes a first magnet and a second magnet secured with a predetermined gap in-between each other, a vibration magnet part interposed between the first magnet and the second magnet which is magnetized to repulse both the first magnet and the second magnet, and an electromagnet part interposed adjacent to the vibration magnet part that changes a magnetic field formed around the vibration magnet part.

The first magnet, the second magnet, and the vibration magnet part may each include a permanent magnet, while an additional weight may be coupled to the vibration magnet part.

The surfaces facing each other of the first magnet and the second magnet may have opposite poles, and the vibration magnet part may include a first vibration magnet magnetized to repulse both the first magnet and the second magnet.

The vibration magnet part may include a plurality of vibration magnets, for example, a second vibration magnet interposed adjacent to the first magnet and magnetized to repulse the first magnet, and a third vibration magnet interposed adjacent to the second magnet and magnetized to repulse the second magnet.

A guide part may also be formed that guides a movement of the vibration magnet part, which may, for example, be made of a guide column having each end coupled respectively to the first magnet and the second magnet. Here, a hole may be formed in the vibration magnet part through which the guide column may be inserted, and the hole may be shaped in correspondence with the shape of the cross-section of the guide column.

In another example, the guide part may include a guide wall interposed adjacent to the perimeter part of the vibration magnet part, where each end of the guide wall may be coupled respectively to the first magnet and the second magnet.

The electromagnet part may include a coil, and a power source that delivers a current to the coil, where the coil may be coupled to the guide part.

The power source part may deliver an alternating current, in which case the current may have a frequency in correspondence with the natural frequency of the linear actuator.

Additional aspects and advantages of the present invention will become apparent and more readily appreciated from the following description, including the appended drawings and claims, or may be learned by practice of the invention.

### BRIEF DESCRIPTION OF THE DRAWINGS

FIG. 1 is a cross-sectional view of a linear actuator according to prior art.

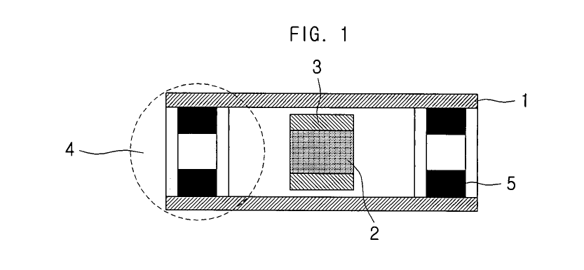

FIG. 2 is a cross-sectional view of a linear actuator according to a first disclosed embodiment of the claimed invention.

FIG. 3 is a cross-sectional view of a linear actuator according to a second disclosed embodiment of the claimed invention.

FIG. 4 is a cross-sectional view of a linear actuator according to a third disclosed embodiment of the claimed invention.

FIG. 5 is a cross-sectional view of a linear actuator according to a fourth disclosed embodiment of the claimed invention.

FIG. 6 is a cross-sectional view of a linear actuator according to a fifth disclosed embodiment of the claimed invention.

FIG. 7 is a cross-sectional view of a linear actuator according to a sixth disclosed embodiment of the claimed invention.

### DETAILED DESCRIPTION

The linear actuator according to certain embodiments of the invention will be described below in more detail with reference to the accompanying drawings, in which those components are rendered the same reference number that are the same or are in correspondence, regardless of the figure number, and redundant explanations are omitted.

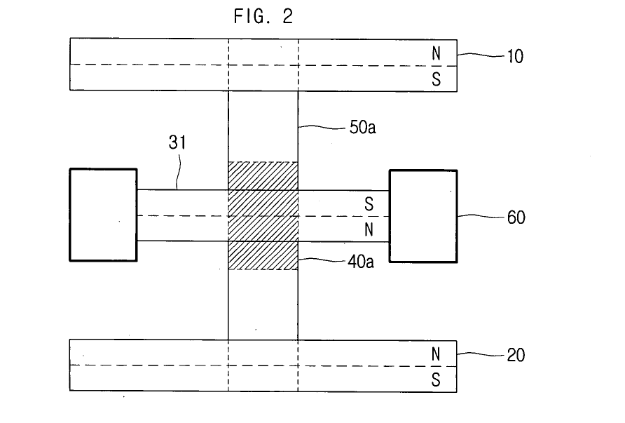

FIG. 2 is a cross-sectional view of a linear actuator according to a first disclosed embodiment of the claimed invention. In FIG. 2 are illustrated a first magnet 10, second magnet 20, first vibration magnet 31, coil 40a, guide column 50a, and additional weight 60.

The first magnet 10 and the second magnet 20 are separated by a predetermined gap and arranged such that the surfaces facing each other have opposite poles. In FIG. 2, the arrangement is such that the S-pole of the first magnet 10 and the N-pole of the second magnet 20 face each other. Of course, the magnets 10, 20 may also be arranged such that the N-pole of the first magnet 10 and the S-pole of the second magnet 20 face each other.

So that a separate power supply is not required, the first magnet 10 and the second magnet 20 may both be made of permanent magnets.

The first magnet 10 and second magnet 20 thus arranged may be secured with a predetermined gap in-between, so that the first magnet 10 and second magnet 20 form a particular magnetic field in the space in-between, without moving.

The distance by which the first magnet 10 and second magnet 20 are separated may act as a factor that affects the natural frequency, as will be described later. Thus, the configuration may be varied according to design requirements.

In the space between the first magnet 10 and the second magnet 20, a first vibration magnet 31 is interposed, on which more description will be provided below.

The first vibration magnet 31 may form the vibration magnet part, which vibrates in-between the first magnet 10 and second magnet 20. While in this embodiment the vibration magnet part is made of the first vibration magnet 31 by itself, the vibration magnet part may also be made of a plurality of vibration magnets. More on this will be described later.

The first vibration magnet 31 may be interposed in the space between the first magnet 10 and second magnet 20 and may be magnetized to repulse both the first magnet 10 and second magnet 20. In FIG. 2, the surface facing the first magnet 10 is an S-pole, while the surface facing the second magnet 20 is an N-pole.

With this configuration, the first vibration magnet 31 may be subject to repulsive forces from both the first magnet 10 and the second magnet 20, and may halt at a particular position at which the two repulsive forces are balanced out. If the first magnet 10 and second magnet 20 are such that have the same characteristics, the first vibration magnet 31 may halt at the midpoint between the first magnet 10 and second magnet 20.

Here, as there is a risk that the first vibration magnet 31 may depart from the space between the first magnet 10 and second magnet 20, a guide part 50a, 50b may be formed which prevents the first vibration magnet 31 from departing.

The guide part 50a, 50b may serve to guide the movement of the first vibration magnet 31. That is, the guide part 50a, 50b may prevent the first vibration magnet 31 from leaving the space between the first magnet 10 and second magnet 20.

In this embodiment, a guide column 50a is presented as the guide part which has one end coupled to the first magnet 10 and the other end coupled to the second magnet 20. Here, a hole (not shown) may be formed in the first vibration magnet 31 that corresponds to the shape of the cross-section of the guide column, so that the guide column 50a may be inserted through.

With this configuration, the first vibration magnet 31 may be prevented from leaving the space between the first magnet 10 and second magnet 20.

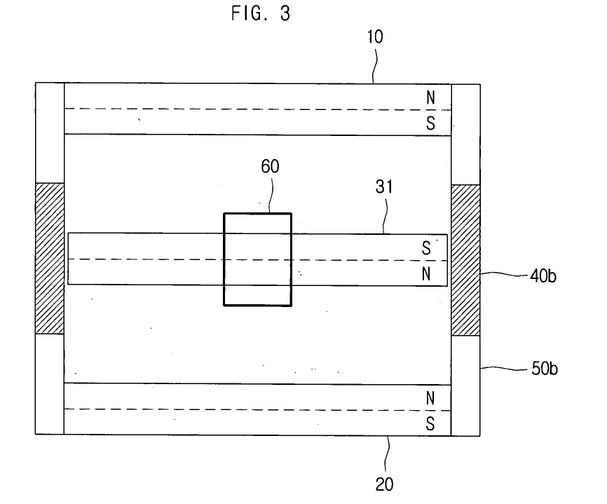

According to a second disclosed embodiment of the claimed invention, a guide wall 50b may also be presented as the guide part which surrounds the outer surface of the first vibration magnet 31. Such a configuration can be seen in FIG. 3.

The guide wall 50b may be formed along the perimeter of the first vibration magnet 31, with one end coupled to the first magnet 10 and the other end coupled to the second magnet 20.

The guide wall 50b may be shaped such that the guide wall 50b completely surrounds every portion of the perimeter of the first vibration magnet 31, but certain portions may be removed according to design considerations.

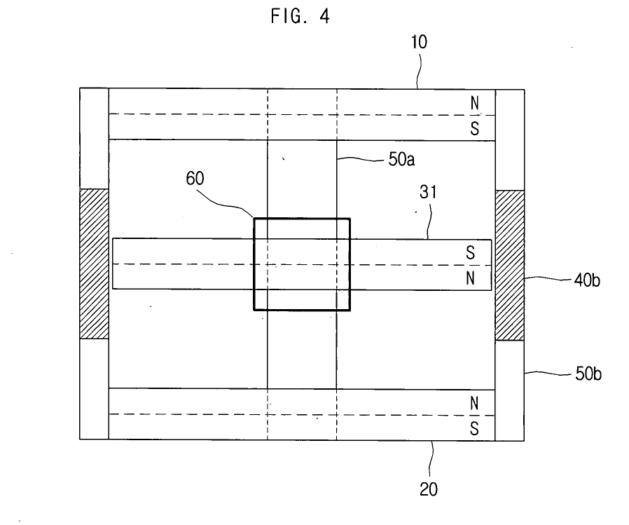

According to a third disclosed embodiment of the claimed invention, the guide column 50a and guide wall 50b described above may be presented together as the guide part. This configuration can be seen in FIG. 4.

The electromagnet part may be used for changing the magnetic field formed around the first vibration magnet 31.

When the electromagnet part is not operated, the first vibration magnet 31 may halt, as described above, at a particular position between the first magnet 10 and second magnet 20 due to the balancing of forces.

When the magnetic field is changed around the halted first vibration magnet 31, the balance of forces applied on the first vibration magnet 31 is changed, whereby the first vibration magnet 31 may be moved. Here, the guide part 50a, 50b may direct the first vibration magnet 31 towards the first magnet 10 or towards the second magnet 20.

In this embodiment, the coils 40a, 40b coupled to the guide part 50a, 50b, and a power source part (not shown) that delivers a current to the coils 40a, 40b may be presented as the electromagnet part. When a current is delivered to the coils 40a, 40b by the power source part (not shown), a magnetic field may be formed around the coils 40a, 40b. Due to the magnetic field formed around the coils 40a, 40b, the external forces applied on the first vibration magnet 31 may be changed.

As the external forces applied on the first vibration magnet 31 are changed, the first vibration magnet 31, which had been halted due to the balance of forces, may be made to move.

The magnetic field formed by the current flowing through the coils 40a, 40b may change according to the direction of the current flowing through the coils. Thus, when an alternating current is supplied to the coils 40a, 40b, the external forces applied on the first vibration magnet 31 may also be changed periodically, so that the first vibration magnet 31 may move back and forth periodically between the first magnet 10 and second magnet 20. With this system, a magnetic spring may be formed.

To increase the efficiency of a linear actuator that includes the magnetic spring described above, the resonance phenomenon may be used. That is, by delivering to the coils a current having a frequency that corresponds with the natural frequency of the magnetic spring, the efficiency of the vibration may be maximized.

In designing the linear actuator in consideration of resonance, an additional weight 60 may be coupled to the first vibration magnet 31. Since the natural frequency of a magnetic spring composed as described above can be represented as a function of the mass of the first vibration magnet 31, the natural frequency may be designed by coupling an additional weight 60 to the first vibration magnet 31 and thereby changing the mass of the first vibration magnet 31.

As described above, the distance between the first magnet 10 and second magnet 20 is also a factor that affects the natural frequency of the magnetic spring. Thus, the natural frequency may also be designed by adjusting the distance between the first magnet 10 and second magnet 20 as well as the additional weight 60.

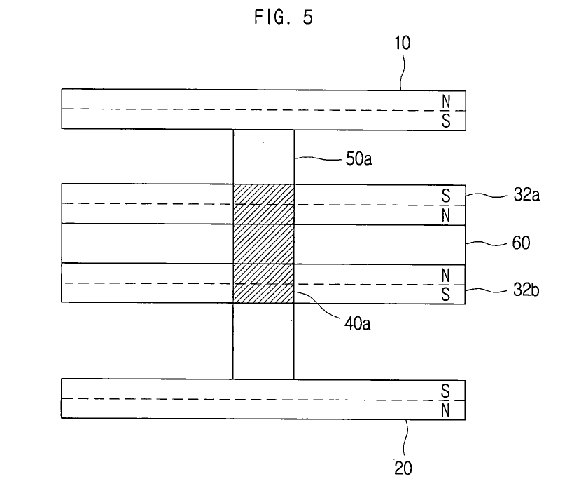

FIG. 5 is a cross-sectional view of a linear actuator according to a fourth disclosed embodiment of the claimed invention. In FIG. 5 are illustrated a first magnet 10, second magnet 20, second vibration magnet 32a, third vibration magnet 32b, coil 40a, guide column 50a, and additional weight 60.

Unlike the previously disclosed embodiments, this embodiment has the vibration magnet part made of a plurality of vibration magnets 32a, 32b.

Thus, the vibration magnet part may be formed to repulse both the first magnet 10 and the second magnet 20, even when the surfaces of the first magnet 10 and second magnet 20 facing each other do not have opposite poles.

Also, by placing an additional weight 60 between the second vibration magnet 32a and the third vibration magnet 32b, the vibration magnets 32a, 32b may be coupled more securely.

While in this embodiment the vibration magnet part is presented as being made with two vibration magnets, it is obvious that the number of vibration magnets may vary, and that the position of the additional weight may also vary.

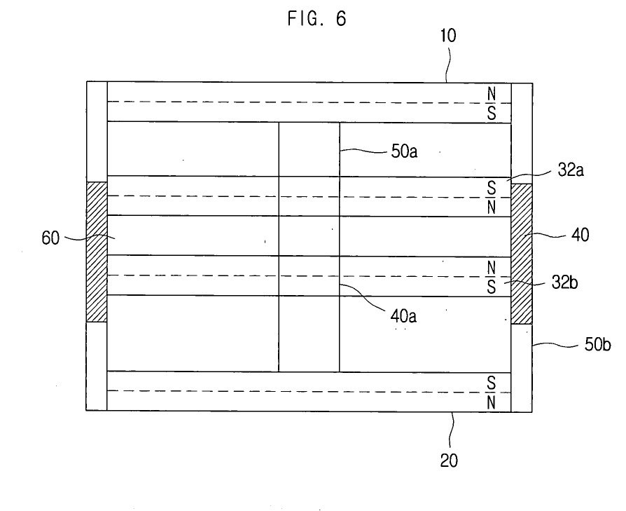

FIG. 6 is a cross-sectional view of a linear actuator according to a fifth disclosed embodiment of the claimed invention. As the embodiment disclosed here is similar to the third disclosed embodiment of the invention shown in FIG. 4, except that the vibration magnet part is made of a plurality of vibration magnets 32a, 32b with an additional weight 60 interposed in-between, the details of this embodiment will not be provided.

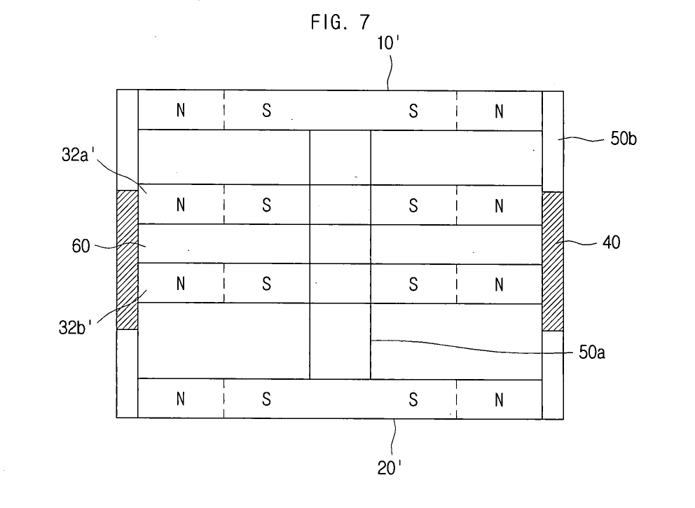

FIG. 7 is a cross-sectional view of a linear actuator according to a sixth disclosed embodiment of the claimed invention. In the linear actuator shown in FIG. 7, the first magnet 10′, second magnet 20′, second vibration magnet 32a′, and third vibration magnet 32b′ are all magnetized in the circumferential direction. In other words, in FIG. 7, the inner portions are magnetized as S-poles, while the outer portions are magnetized as N-poles.

While in this embodiment, all of the magnets are presented as having S-poles for the inner portions and N-poles for the outer portions, it may be sufficient to have the first magnet 10′ and the second vibration magnet 32a′ magnetized to repulse each other, and the second magnet 20′ and the third vibration magnet 32b′ magnetized to repulse each other.

In other words, the first magnet 10′ and the second vibration magnet 32a′ may have the inner portions magnetized to be S-poles and the outer portions magnetized to be N-poles, while the second magnet 20′ and the third vibration magnet 32b′ may have the inner portions magnetized to be N-poles and the outer portions magnetized to be S-poles.

As the other features of this embodiment are identical or similar to the fifth disclosed embodiment of the invention shown in FIG. 6, the details will not be provided.

Next, the operation will now be described of a linear actuator based on an embodiment set forth above. For convenience, the description will focus on a linear actuator according to the first disclosed embodiment of the invention shown in FIG. 2.

When the electromagnet part is not operated, i.e. when a current is not delivered to the coil 40a, the first vibration magnet 31 may remain halted at a particular position between the first magnet 10 and second magnet 20, due to the magnetic forces applied by the first magnet 10 and second magnet 20.

Here, when a current is delivered to the coil 40a, a change occurs in the external forces applied to the first vibration magnet 31, whereby the first vibration magnet 31 may move in a direction towards the first magnet 10 or the second magnet 20. When the first vibration magnet 31 approaches the first magnet 10 or second magnet 20, a change occurs again in the external forces applied on the first vibration magnet 31, due to the repulsive forces between magnets, and if the current delivered to the coil 40a alternates in accordance, the first vibration magnet 31 may change its direction of motion. When such actions are repeated, the first vibration magnet 31 may be made to move back and forth between the first magnet 10 and the second magnet 20.

If the frequency of the current delivered to the coil 40a is designed to correspond with the natural frequency of the magnetic spring, the resonance phenomenon may be used to maximize vibration efficiency.

As set forth above, a linear actuator based on an embodiment of the claimed invention may provide high efficiency, by forming a magnetic spring from the repulsive forces of magnets and using the resonance of the magnetic spring.

While the present invention has been described with reference to particular embodiments, it is to be appreciated that various changes and modifications may be made by those skilled in the art without departing from the spirit and scope of the present invention, as defined by the appended claims and their equivalents.

What is claimed is:

1. A linear actuator comprising:
a first magnet and a second magnet secured with a predetermined gap in-between;
a vibration magnet part interposed between the first magnet and the second magnet and magnetized to repulse both of the first magnet and the second magnet; and
an electromagnet part interposed adjacent to the vibration magnet part and configured to change a magnetic field formed around the vibration magnet part.

2. The linear actuator of claim 1, wherein each of the first magnet, the second magnet, and the vibration magnet part comprises a permanent magnet.

3. The linear actuator of claim 1, further comprising an additional weight coupled to the vibration magnet part.

4. The linear actuator of claim 1, wherein surfaces of the first magnet and the second magnet facing each other have opposite poles, and
the vibration magnet part comprises a first vibration magnet magnetized to repulse both of the first magnet and the second magnet.

5. The linear actuator of claim 1, wherein the vibration magnet part comprises a plurality of vibration magnets.

6. The linear actuator of claim 5, wherein the vibration magnet part comprises:
a second vibration magnet interposed adjacent to the first magnet and magnetized to repulse the first magnet; and
a third vibration magnet interposed adjacent to the second magnet and magnetized to repulse the second magnet.

7. The linear actuator of claim 1, further comprising a guide part configured to guide a movement of the vibration magnet part.

8. The linear actuator of claim 7, wherein the guide part comprises a guide column having each end coupled respectively to the first magnet and the second magnet, and
the vibration magnet part has a hole formed therein, the guide column configured to be inserted through the hole.

9. The linear actuator of claim 8, wherein the hole is shaped in correspondence with a shape of a cross-section of the guide column.

10. The linear actuator of claim 7, wherein the guide part comprises a guide wall interposed adjacent to the perimeter part of the vibration magnet part, each end of the guide wall coupled respectively to the first magnet and the second magnet.

11. The linear actuator of claim 1, wherein the electromagnet part comprises a coil, and a power source configured to deliver a current to the coil.

12. The linear actuator of claim 11, wherein the coil is coupled to the guide part.

13. The linear actuator of claim 11, wherein the power source part is configured to deliver an alternating current.

14. The linear actuator of claim 13, wherein the current has a frequency in correspondence with a natural frequency of the linear actuator.
